(19) United States
(12) Patent Application Publication
(10) Pub. No.: US 2003/0151593 A1
(43) Pub. Date: Aug. 14, 2003

(54) Portable wireless rechargeable optical sliding-mouse-pen

(75) Inventor: Hsuan Mu Hong, Taipei (TW)

Correspondence Address: BACON & THOMAS, PLLC, 625 SLATERS LANE, FOURTH FLOOR, ALEXANDRIA, VA, 22314

(73) Assignee: ASOKA INC., Taipei (TW)

(21) Appl. No.: 10/073,247

(22) Filed: Feb. 13, 2002

(51) Int. Cl. G09G 5/08; G09G 5/00

(52) U.S. Cl. 345/163; 345/166; 345/179

(57) ABSTRACT

The invention is a mini pen-like wireless optical sliding-mouse with inner rechargeable battery (or discarding). It is unnecessary for usual battery exchanging. It is a portable sliding-mouse without external electric cable. It is very convenient for using and carrying.

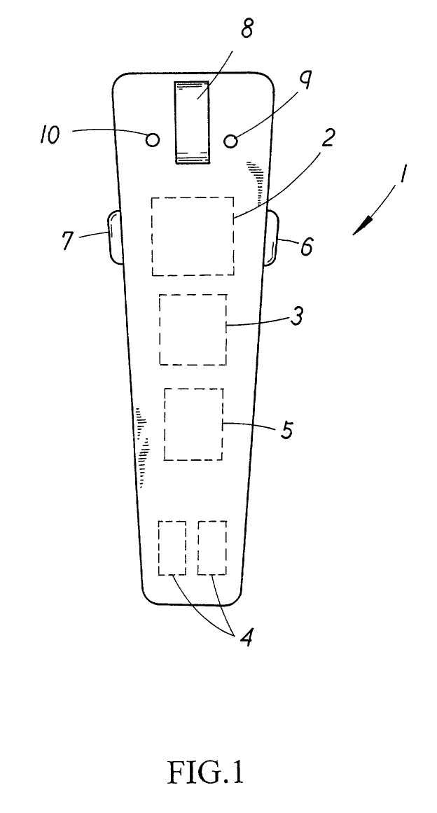

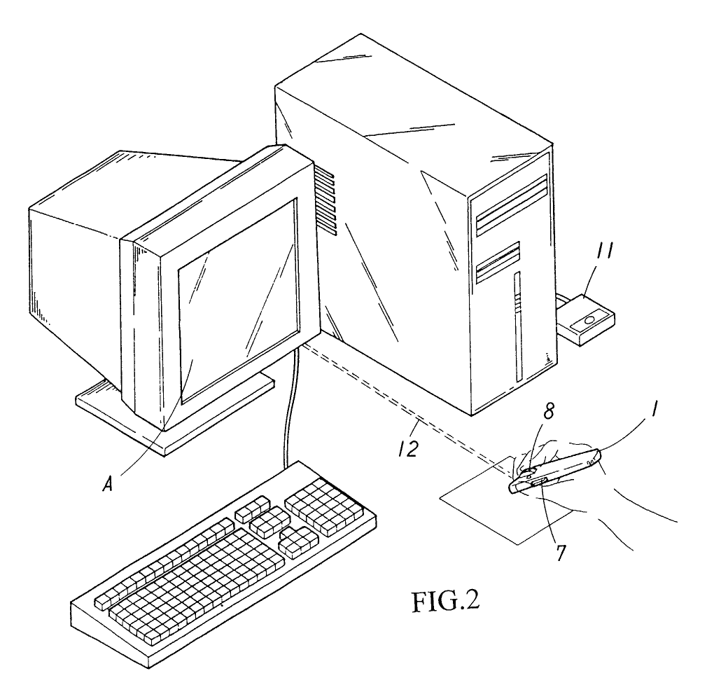

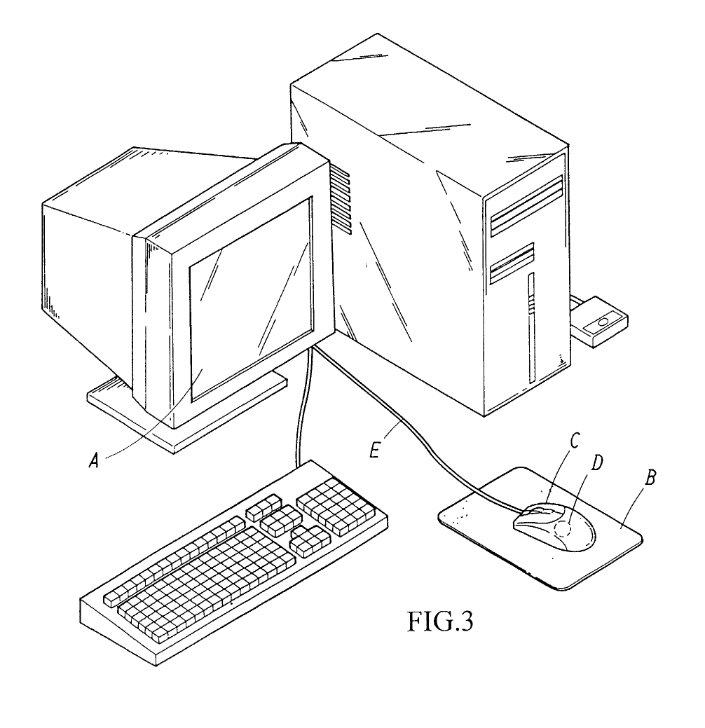

### BACKGROUND OF THE INVENTION

1. Filed of the Invention

A super mini, portable object with no battery charging is used in household electric appliance. (Including notebook, PC, children computer of intellect exploitation, personal digital assistant PDA and game machine, etc.)

2. Description of the Related Art

As disclosed in Picture 3, beside the monitor of computer (A) there is a sliding-mouse mat (B) on which a wiring sliding-mouse (C) is moving freely for the use of rolling ball (D) of its button, but the wiring sliding-mouse (C) is usually limited for its wire (E). Though the siring sliding-muse (C) is simplified for its using, the wire (E) is still troublesome, which makes its function discountable. Hereby, wireless sliding-mouse has appeared.

The appearance of wireless sliding-mouse has solved the problem, but some still occur. For example, both wiring and wireless sliding-mice have their rolling balls (C) at the button which can not work properly or do damage to its inner structure after a long time. Such shortcoming can distort their function. Furthermore, their volumes are so big that they are inconvenient in travel. It occupies much room. If such problem can be solved, the sliding-mouse can of course work better.

### SUMMARY OF THE INVENTION

A kind of equipment like pen is mixed with the integrated circuit of optical picture-sensor, radio frequency emitting circuit and quickly rechargeable battery, which can be easily carried. It can coordinate well with computer in use. This is our aim of invention.

Besides, it is used as pen-like sliding-muse with rechargeable battery (or discarding) and unnecessary usually for battery changing. It is wireless and portable with convenience. This is another aim of invention.

### BRIEF DESCRIPTION OF THE DRAWINGS

Drawing 1, instruction drawing

Drawing 2, reference drawing

Drawing 3, instruction drawing for computer use

### DETAILED DESPRITION OF PREFERENCED EMBODIMENT

For reference of Drawings 1 and 2, the sliding-mouse pen itself (1) is front wide and rear narrow. A rolling ball (8) is set on the top, beside which two lights (9) of recharging and lack-of-power indicating are (10). An optical integrated circuit (2) is on the rear beside which there are the left (7) and right (6) buttons. At the rear of optical integrated circuit (2) are RF molding group (3), recharging base (5) and rechargeable battery (4), etc.

When in practice, user should at first hold the structure (1), all its sliding actions can be detected by the optical integrated circuit (2). A group of integrated information from RF mold group (3) is emitted to the air. A receiver (11) can receive the RE loading wave, and analyze and recover information through processing to computer. In this way, the venire can react with user's movement, so this is a series of functions of sliding mouse. When user knows its weakness on power from its indicating light (10), a recharging wire (12) can be used injecting into computer's USB for battery recharging and meanwhile it can still work. As illustrating in Drawing 2, it can solve the problem that it does not need battery exchanging and it is with no battery.

Putting together, the invention is a mini pen-like wireless optical sliding-mouse with inner rechargeable battery (or discarding). It is unnecessary for usual battery exchanging. It is a portable sliding-mouse without external electric cable. It is very convenient with its addition value. It is with “New and Original, Practical and Advanced” principles etc for new patent application. Hereby, we apply for a patent with this introduction and hope the bureau can make it verified as soon as possible.

What is claimed is:

1. A “portable wireless optical rechargeable sliding-mouse pen” is:
A sliding-mouse pen, front wide and rear narrow in its pen-like structure.
A rolling ball is set on the top, beside which two lights of recharging and lack-of-power indicating are. An optical integrated circuit is on the rear of rolling ball, beside which there are the left and right buttons. At the rear of the optical integrated circuit are RF molding group, recharging base and rechargeable battery, etc. It is very convenient for carrying.
